(19) United States
(12) Patent Application Publication
(10) Pub. No.: US 2017/0190429 A1
(43) Pub. Date: Jul. 6, 2017

(54) AIR CONDITIONING SYSTEM

(71) Applicant: AIRBUS OPERATIONS S.L., Madrid (ES)

(72) Inventor: Carlos CASADO MONTERO, Madrid (ES)

(21) Appl. No.: 15/395,365

(22) Filed: Dec. 30, 2016

(30) Foreign Application Priority Data
Dec. 30, 2015 (EP) 15382677.1

(51) Int. Cl. B64D 13/08

(52) U.S. Cl. CPC B64D 13/08; B64D 2013/0688

(57) ABSTRACT

An air conditioning system 1 for a cabin 6 of an aircraft. The air conditioning system 1 includes a work air source 2 suitable for providing work air, a distribution and control system 3, a main heat exchanger 4, a turbine 5 and a compressor 7. The inlet 51 of the turbine 5 is in fluid communication with an outlet 61 of the cabin 6 and the outlet 52 of the turbine 5 is in fluid communication with ambient. The inlet 71 of the compressor is suitable for being fed by the work air, and the outlet 72 of the compressor is in fluid communication with the inlet 41 hot side of the main heat exchanger 4, the compressor 7 being moved by the outlet shaft 53 of the turbine 5. The outlet 42 of the hot side of the main heat exchanger 4 is in fluid communication with the inlet 31 of the distribution and control system 3, the outlet 32 of which is in turn in fluid communication with an inlet of the cabin 6.

### RELATED APPLICATION

This application claims priority to European Patent Application EP15382677.1, filed Dec. 30, 2015, the entirety of which is incorporated by reference.

### FIELD OF THE INVENTION

The present invention is relates to aircraft, in particular to the field of air conditioning systems for aircraft.

### BACKGROUND OF THE INVENTION

Air conditioning systems in aircraft provide conditioned air for the comfort of passengers in the aircraft. Compressed air is obtained from a pressurized air source, usually from an aircraft engine or an Auxiliary Power Unit APU. The compressed air is treated, usually following an inverse Brighton cycle, in an air conditioning system.

Usually the air taken from the aircraft engines or the APU while the aircraft is in flight and at high altitude remains constant at a certain pressure regardless of the altitude of the aircraft. Because ambient pressure, e.g., the pressure of the outside air surrounding the aircraft, decreases with the altitude, the pressure step increases with altitude between the ambient air and the pressure of the air taken from the aircraft engines or APU.

The passenger cabin is supplied with air that remains at higher pressure than ambient pressure and is provided at approximately the same rate to the cabin throughout the flight of the aircraft. The air evacuates from the cabin through different outlets, such as through outflow valves. The air evacuates from the cabin to the ambient air surrounding the aircraft. Conventional practice is to gain no major benefit to the aircraft in evacuating the cabin air.

The conventional system for providing air to the cabin is typically decoupled from the system that evacuates air from the cabin. Further, conventional practice is that the air evacuated from the cabin is not used to produce energy.

### SUMMARY OF THE INVENTION

The present invention gets power from air evacuated from an aircraft cabin and before this air is discharged to the ambient atmosphere surrounding the aircraft. The power gained from the evacuation of the air is applied to treat work air for the air conditioning system coming from a power source, such as an engine of the aircraft, APU or other drive compressor. The treatment of the air reduces the power need to provide air for the cabin and thereby reduces fuel consumption by the aircraft.

The present invention provides an air conditioning system for a cabin of an aircraft, the air conditioning system comprising: a work air source suitable for providing work air; a distribution and control system, with an inlet and an outlet; a main heat exchanger with a hot side comprising an inlet and an outlet; a turbine with an inlet and an outlet, the inlet of the turbine being in fluid communication with an outlet of the cabin and the outlet of the turbine being in fluid communication with ambient air; the turbine further comprising an outlet shaft suitable for outputting energy generated by air passing through the turbine; a compressor with an inlet and an outlet, the inlet of the compressor is suitable for being fed by the work air, and the outlet of the compressor being in fluid communication with the inlet hot side of the main heat exchanger, the compressor being moved by the outlet shaft of the turbine; the outlet of the hot side of the main heat exchanger being in fluid communication with the inlet of the distribution and control system, the outlet of which is in turn in fluid communication with an inlet of the cabin.

This air conditioning system is provided with pressurized air at a lower pressure as usual, since the remainder pressure is provided by the turbo-compressor system coupled to the system. As a consequence, energy is saved from the system, and fuel consumption is reduced.

In a particular embodiment, the air conditioning system further comprises a supplementary heat exchanger by means of which heat is transferred between the outlet of the compressor and the inlet of the turbine. The supplementary heat exchanger improves the efficiency of the turbo-compressor system.

In a particular embodiment, the air conditioning system further comprises: an ambient sensor pressure and a cabin sensor pressure, suitable for providing a pressure value, which is the difference between ambient pressure and cabin pressure; and a first valve suitable for controlling the flow through the inlet of the compressor depending on the pressure value. The first valve allows the system to operate in an optimised way, as the system works better when cabin pressure is greater than the ambient pressure.

In a particular embodiment, the air conditioning system further comprises an air cycling machine, which contains the heat exchanger and further comprises at least a turbine, a compressor and a secondary heat exchanger.

In a particular embodiment, the air conditioning system further comprises a one way valve between the outlet of the compressor and the inlet of the hot side of the main heat exchanger.

In a particular embodiment, the air conditioning system further comprises a one way valve between the outlet of the cabin and the inlet of the turbine; and a second valve in the outlet of the cabin.

In a particular embodiment, the air conditioning system further comprises a one way valve in the outlet of the turbine.

In a particular embodiment, the pressurized air source is one of a bleed air duct of an engine or an APU.

In a particular embodiment, the pressurized air source is a ram air duct. In a particular embodiment, the pressurized air source is a ram air duct and a compressor.

In a particular embodiment, the air conditioning system further comprises a first electric motor suitable for driving the compressor.

In a particular embodiment, the air conditioning system further comprises a second compressor with an inlet and an outlet, the inlet being in fluid connection with ambient and the outlet being in fluid connection with the inlet of the hot side of the main heat exchanger.

In a particular embodiment, the air conditioning system further comprises a second electric motor suitable for driving the second compressor.

The invention may be embodied as an aircraft comprising an air conditioning system as described herein.

### DESCRIPTION OF THE DRAWINGS

These and other characteristics and advantages of the invention will be clearly understood in view of the detailed description of the invention and further in view of the preferred embodiments of the invention, with reference to the drawings. Preferred embodiments are given just as examples and are not intended to limit the scope of the present invention.

FIG. 1 is a schematic diagram of a first embodiment of an air conditioning system according to the invention.

FIG. 2 is a schematic diagram of a second embodiment of an air conditioning system according to the invention.

### DETAILED DESCRIPTION OF THE INVENTION

Having outlined the object of the invention, specific non-limitative embodiments are described hereinafter.

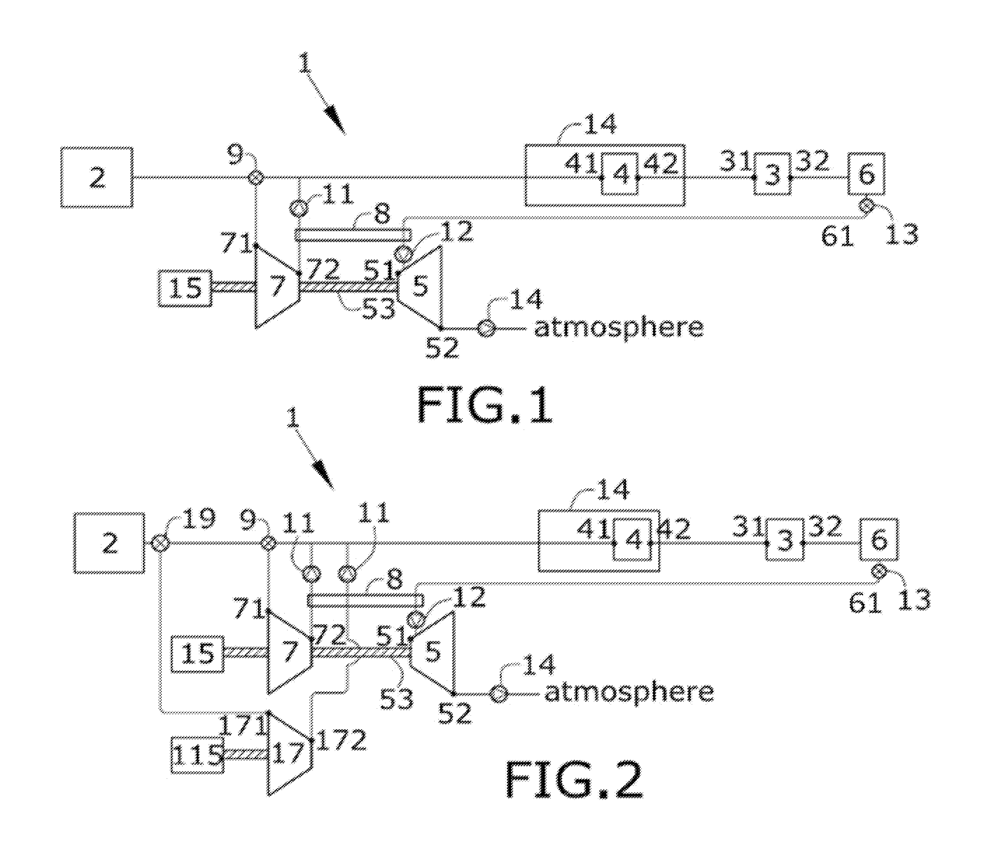

FIG. 1 shows an exemplary embodiment of an air conditioning system 1 suitable for providing working air, e.g., air for the passengers to breath, to a passenger cabin 6 of an aircraft. The air conditioning system 1 comprises: a work air source 2 suitable for providing the work air; a distribution and control system 3 with an inlet 31 and an outlet 32 a main heat exchanger 4 with a hot side comprising an inlet 41 and an outlet 42; a turbine 5; and a main compressor 7.

The outlet 42 of the hot side of the main heat exchanger 4 is in fluid communication with an inlet of the cabin 6.

The pressurized work air source 2 is at least one of a bleed air duct of an engine or an APU or ambient air. This work air is useful for feeding the hot side of the heat exchanger 4 and, once it has been cooled, then introduced into the cabin 6. But in this particular embodiment, this work air is made pass through the main compressor 7.

The turbine comprises an inlet 51 and an outlet 52, the inlet 51 of the turbine 5 being in fluid communication with an outlet 61 of the cabin 6 and the outlet 52 of the turbine 5 being in fluid communication with ambient. The turbine is then fed with air exiting the cabin. This air exiting the cabin is useful for providing energy in the turbine. Once the air exiting the cabin has passed through the turbine, it is exhausted into the atmosphere.

The turbine 5 further comprises an outlet shaft 53 suitable for outputting energy generated by the dirty air passing through the turbine 5. This outlet shaft 53 is useful for moving the main compressor 7.

The main compressor 7 comprises an inlet 71 and an outlet 72, the inlet 71 of the main compressor 7 being fed by the work air, and the outlet 72 of the main compressor 7 being in fluid communication with the inlet 41 of the hot side of the main heat exchanger 4. The outlet 42 of the hot side of the main heat exchanger 4 is in fluid communication with the inlet 31 of the distribution and control system 3, the outlet 32 of which is in turn in fluid communication with an inlet of the cabin 6. As a consequence, the work air which has been provided by the pressurized air source 2 is introduced into the cabin 6, after passing through the compressor 7, the heat exchanger 4 and the control system 3. The compressor 7 increases the pressure of the work air, so it is not necessary to obtain work air at a high pressure, thus saving energy and fuel consumption.

A supplementary heat exchanger 8 transfers heat from the outlet 72 of the compressor 7 to the inlet 51 of the turbine 5, thus increasing the performance of the turbine 5 and compressor 7 assembly.

This system also comprises an ambient sensor pressure and a cabin sensor pressure, suitable for providing a pressure value, which is the difference between ambient pressure and cabin pressure. A first valve 9, further comprised in this system, is suitable for controlling the flow through the inlet 71 of the compressor 7 depending on the pressure value, since this system works better when the pressure value is greater than 15 MPa.

The heat exchanger 4 may be part of an air cycling machine 14 which further comprises at least a turbine, a compressor and a secondary heat exchanger.

The air conditioning system 1 may further comprises valves, such as: (i) a one way valve 11 between the outlet 72 of the compressor and the inlet 41 of the hot side of the main heat exchanger 4; (ii) a one way valve 12 between the outlet 61 of the cabin and the inlet 51 of the turbine 5; (iii) a second valve 13 in the outlet 61 of the cabin 6; and (iv) a one way valve 14 in the outlet 52 of the turbine 5.

A first electric motor 15 mad drive the compressor 7, both when the turbine 5 is not working and when the turbine 5 is working and the air conditioning system 1 requires a higher pressure.

FIG. 2 shows a different embodiment of an air conditioning system 1 which is similar in many respects to the system shown in FIG. 1 as is evident from the common reference numbers. The system 1 in FIG. 2 includes a second electric motor 115 for driving a second compressor 17. The second compressor 17 comprises an inlet 171 and an outlet 172, wherein the inlet 171 is in fluid connection with ambient and the outlet 172 is in fluid connection with the inlet 41 of the hot side of the main heat exchanger 4. This second compressor 17 is driven by the second electric motor 115.

While at least one exemplary embodiment of the present inventions is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiments. In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. An air conditioning system for a cabin of an aircraft, the air conditioning system comprising:
a work air source suitable for providing work air;
a distribution and control system, with an inlet and an outlet;
a main heat exchanger with a hot side comprising an inlet and an outlet;
a turbine with an inlet and an outlet, the inlet of the turbine being in fluid communication with an outlet of the cabin and the outlet of the turbine being in fluid communication with ambient; the turbine further comprising an outlet shaft suitable for outputting energy generated by air passing through the turbine;
a compressor with an inlet and an outlet, the inlet of the compressor suitable for being fed by the work air, and the outlet of the compressor being in fluid communication with the inlet hot side of the main heat exchanger, the compressor being moved by the outlet shaft of the turbine; and
the outlet of the hot side of the main heat exchanger being in fluid communication with the inlet of the distribution and control system, the outlet of which is in turn in fluid communication with an inlet of the cabin.

2. The air conditioning system according to claim 1, further comprising a supplementary heat exchanger by means of which heat is transferred between the outlet of the compressor and the inlet of the turbine.

3. The air conditioning system according to claim 1, further comprising:
an ambient sensor pressure and a cabin sensor pressure, suitable for providing a pressure value, which is the difference between ambient pressure and cabin pressure; and
a first valve suitable for controlling the flow through the inlet of the compressor depending on the pressure value.

4. The air conditioning system according to claim 1, wherein the heat exchanger is comprised in an air cycling machine which further comprises at least a turbine, a compressor and a secondary heat exchanger.

5. The air conditioning system according to claim 1, further comprising a one way valve between the outlet of the compressor and the inlet of the hot side of the main heat exchanger.

6. The air conditioning system according to claim 1, further comprising:
a one way valve between the outlet of the cabin and the inlet of the turbine; and
a second valve in the outlet of the cabin.

7. The air conditioning system according to claim 1, further comprising a one way valve in the outlet of the turbine.

8. The air conditioning system according to claim 1, wherein the pressurized air source is at least one of a bleed air duct of an aircraft engine and an auxiliary power unit.

9. The air conditioning system according to claim 1, wherein the pressurized air source is a ram air duct.

10. The air conditioning system according to claim 1, further comprising a first electric motor suitable for driving the compressor.

11. The air conditioning system according to claim 1, further comprising a second compressor with an inlet and an outlet, the inlet being in fluid connection with ambient and the outlet being in fluid connection with the inlet of the hot side of the main heat exchanger.

12. The air conditioning system according to claim 11, further comprising a second electric motor suitable for driving the second compressor.

13. An aircraft comprising an air conditioning system according to claim 1.

14. An aircraft air conditioning system comprising:
a work air flow passage having an inlet coupled to a source of pressurized pair and an outlet coupled to a cabin of an aircraft;
a main heat exchanger including a hot side passage included in the work air flow passage;
an evacuation flow passage having an inlet configured to receive air evacuated from the cabin;
a turbine in the evacuation flow passage, wherein an inlet to the turbine receives evacuated air from the cabin and an outlet of the turbine discharges the evacuated air to flow to ambient air outside of the aircraft; and
a compressor driven by the turbine, wherein the compressor is in the work air flow passage such that an inlet to the compressor is configured to receive work air from the work air flow passage, the compressor is configured to compress the work air, and an outlet of the compressor is configured to provide compressed work air to the work air flow passage such that the compressed work air flows to the hot side of the main heat exchanger.

15. The aircraft air conditioning system of claim 14 further comprising a supplementary heat exchanger having a hot passage included in the work air flow passage and receiving the compressed work air from the compressor, and a cold passage in the evacuation flow passage and discharging the evacuated air to the inlet to the turbine.

16. The aircraft air conditioning system according to claim 14, further comprising:
an ambient sensor pressure and a cabin sensor pressure configured to generate a pressure difference value indicative of a difference between ambient pressure and cabin pressure; and
a first valve in the work air flow passage and upstream of the compressor, wherein the first valve directs the work air to the compressor if the pressure difference value exceeds a threshold and the first valve divers the work air away from the compressor and to the main heat exchanger if the pressure difference value is less than the threshold.

17. The aircraft air conditioning system according to claim 14, further comprising a one way valve between the outlet of the compressor and an inlet of the main heat exchanger.

18. The aircraft air conditioning system according to claim 14, further comprising a one way valve in the evacuation flow passage and between an outlet of the cabin and the inlet of the turbine.

19. The aircraft air conditioning system according to claim 14, wherein the source of the pressurized air is at least one of a bleed air duct of an aircraft engine and an auxiliary power unit.

20. The aircraft air conditioning system according to claim 14, further comprising a motor coupled to the compressor and configured to drive the compressor.
